(19) United States
(12) Patent Application Publication
(10) Pub. No.: US 2025/0115071 A1
(43) Pub. Date: Apr. 10, 2025

(54) IMAGE DISTORTION FOR SINGLE PASS PRINTING

(71) Applicant: Taylor Made Golf Company, Inc., Carlsbad, CA (US)

(72) Inventors: Christian MAURER, Fountain Inn, SC (US); Tim DURHAM, Cleveland, SC (US)

(21) Appl. No.: 18/905,791

(22) Filed: Oct. 3, 2024

Related U.S. Application Data
(60) Provisional application No. 63/588,194, filed on Oct. 5, 2023.

(51) Int. Cl. B41M 5/00; B41J 3/407; B41M 3/00; G06K 15/02

(52) U.S. Cl. CPC B41M 5/0088; B41J 3/40733; B41M 3/008; G06K 15/1894; G06K 2215/101

(57) ABSTRACT

Single pass printing methods designed to reduce or prevent unwanted image distortion and/or image defects when printing on a ball. In some embodiments, the methods can comprise printing ink droplets based on a distorted pixel map comprising a plurality of pixel areas distorted in at least one of a width direction and a height direction, wherein select pixel areas are removed from the distorted pixel map. In some embodiments, a distorted pixel map can comprise a plurality of undistorted pixel areas and a plurality of pixel areas distorted in at least one of a width direction and a height direction.

### CROSS-REFERENCE TO RELATED APPLICATION

This application claims priority to U.S. Provisional Application No. 63/588,194, filed Oct. 5, 2023, which is incorporated herein in its entirety by reference thereto.

### FIELD

The present disclosure relates to single pass printing methods and images printed using these methods. In particular, the present disclosure relates to single pass printing methods for printing on spherical balls and balls with single-pass-printed images printed thereon.

### BACKGROUND

Images printed on a ball, for example a golf ball, can serve various functions, including identifying a particular ball, providing an alignment feature, and/or customizing a ball to a player's liking. The clarity and aesthetics of the printed images on the golf ball can be important for a player.

Images printed on a spherical ball, for example a golf ball, can be printed using single pass printing technology, for example, single pass inkjet printing technology, where the ball passes under or adjacent to a printer head while rotating at a predetermined speed. With single pass printers, the ball can pass under or adjacent to one or more printer heads only once, producing high throughput speeds for mass production. In some cases, single pass systems are able to run at extremely high speeds, up to 50 inches per second and higher.

However, printing images using single pass technology creates a unique set of challenges for reliably, consistently, and clearly printing images. In particular, avoiding image distortion can be a challenge because the image is quickly printed on a rotating ball in a single printing pass. Unless properly accounted for, the rotation of the ball and the curvature of the ball's surface can cause undesired image distortion.

Hence, what is needed are single pass printing methods configured to reduce image distortion and/or image defects, thereby facilitating reliable, consistent, and clear single pass printing of images.

### BRIEF DESCRIPTION OF THE DRAWINGS/FIGURES

The accompanying drawings, which are incorporated herein and form a part of the specification, illustrate the present disclosure and, together with the description, further serve to explain the principals thereof and to enable a person skilled in the pertinent art to make and use the same. Aspects of the present disclosure are best understood from the following detailed description when read with the accompanying figures. It is noted that, in accordance with the standard practice in the industry, features are not drawn to scale. In fact, the dimensions of the features may be arbitrarily increased or reduced for clarity of discussion.

FIG. 1 illustrates a single pass printing system according to some embodiments.

FIG. 2 illustrates a printed image and image lines according to some embodiments.

FIG. 3 illustrates a printed image and image lines according to some embodiments.

FIG. 4 illustrates image lines for a flat representation of an image according to some embodiments.

FIG. 5 illustrates a spherical polar coordinate system for determining locations on the surface of a sphere in terms of Cartesian coordinates (x, y, z).

FIG. 6 illustrates a ball comprising one or more images according to some embodiments.

FIG. 7 illustrates pixel maps according to some embodiments.

FIG. 8 illustrates an overlap of the two distorted pixel maps shown in FIG. 7.

FIG. 9A illustrates an undistorted image according to some embodiments. FIG. 9B illustrates a distorted image according to some embodiments.

FIG. 10A illustrates an undistorted image according to some embodiments. FIG. 10B illustrates a distorted image according to some embodiments.

FIG. 11 illustrates a pixel map with removed pixel areas according to some embodiments.

FIG. 12 illustrates a single pass printing layout according to some embodiments.

FIG. 13 illustrates a single pass printing layout according to some embodiments.

### BRIEF SUMMARY

The present disclosure describes single pass printing methods for printing one or more images on a ball, and balls comprising one or more images printed using the single pass printing methods described.

A first embodiment (1) of the present application is directed to a single pass printing method for a spherical ball, the method comprising rotating the spherical ball on a central axis of the ball, printing an image on the ball with a plurality of printing nozzles while the ball is rotating; wherein: the image on the ball is defined by an image area profile comprising a top boundary line and a bottom boundary line; the image is printed by printing ink droplets correlating to pixels arranged in consecutive image lines, each image line defined by a plurality of the pixels disposed between the top boundary line and the bottom boundary line, and each pixel comprising at least one of the ink droplets that forms the image; and the ink droplets are printed by: applying the pixels to a distorted pixel map comprising pixel areas corresponding with the pixels and comprising a plurality of undistorted pixel areas and a plurality of pixel areas distorted in at least one of a width direction and a height direction, selectively removing pixels areas from the distorted pixel map, printing the ink droplets based on the distorted pixel map with the pixel areas removed.

A second embodiment (2) of the present application is directed to a single pass printing method for a spherical ball, the method comprising: applying an image to an undistorted pixel map to create a pixelated image area profile for the image; determining a print location of the image on a surface of the ball; pre-distorting the pixelated image area profile based on the print location and a distorted pixel map comprising a plurality of undistorted pixel areas and a plurality of pixel areas distorted in at least one of a width direction and a height direction, to thereby create a distorted pixelated image area profile for the image; selectively removing pixels areas from the distorted pixelated image area profile; and single pass printing the image on the surface of the ball based on the distorted pixelated image area with the pixels areas removed while the ball is rotating on a central axis of the ball.

A third embodiment (3) of the present application is directed to single pass printed golf ball, comprising: a top pole, a bottom pole opposite the top pole, and an equator equidistant from the top pole and the bottom pole, wherein a central axis of the ball runs between the top pole and the bottom pole; a manufacturer's logo within a first image boundary area located on the equator, wherein the manufacturer's logo is defined based on an undistorted pixel map for the manufacturer's logo; and an image within a second image boundary area located adjacent the first image boundary area, wherein the image is defined based on a distorted pixel map for the image that comprises a plurality of pixel areas distorted in at least one of a width direction and a height direction, and wherein select pixel areas are removed from the distorted pixel map.

A fourth embodiment (4) of the present application is directed to a single pass printing method for a spherical ball, the method comprising: rotating the spherical ball on a central axis of the ball; and printing a manufacture's logo and an image on the ball with a plurality of printing nozzles while the ball is rotating; wherein: the manufacture's logo is printed in a first image boundary area located on an equator of the ball, the image is printed in second image boundary area located below the first image boundary area, the manufacture's logo is printed by printing ink droplets correlating to pixels arranged in consecutive image lines within the first image boundary area, each image line defined by a plurality of the pixels, and each pixel comprising at least one of the ink droplets that forms the manufacture's logo, the image is printed by printing ink droplets correlating to consecutive pixels arranged in image lines within the second image boundary area, each image line defined by a plurality of the pixels, and each pixel comprising at least one of the ink droplets that forms the image, and the ink droplets for the image are printed by: applying the pixels of the image to a distorted pixel map comprising pixel areas corresponding with the pixels of the image and comprising a plurality of pixel areas distorted in at least one of a width direction and a height direction, selectively removing pixels areas from the distorted pixel map, and printing the ink droplets based on the distorted pixel map with the pixel areas removed.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting.

As used herein, the term “about” refers to a value that is within +10% of the value stated. For example, about 3 millimeter can include any number from 2.7 millimeters to 3.3 millimeters.

As used herein, unless specified otherwise, references to “first,” “second,” “third,” “fourth,” etc. are not intended to denote order, or that an earlier-numbered feature is required for a later-numbered feature. Also, unless specified otherwise, the use of “first,” “second,” “third,” “fourth,” etc. does not necessarily mean that the “first,” “second,” “third,” “fourth,” etc. features have different properties, values, or characteristics.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

Embodiments described herein comprise single pass printing methods configured to reduce image distortion and/or image defects, thereby facilitating reliable, consistent, and clear single pass printing of images. Embodiments described herein comprise methods for pre-distorting images such that they are printed, and therefore appear, in an undistorted fashion on the surface of ball.

In embodiments described herein, a pixelated image area profile can be distorted based on distorted pixel map comprising pixel areas corresponding with pixels of the image area profile. The degree and direction of distortion for pixel areas in a distorted pixel map can be based on the location of an image on a ball, the curvature of the ball, or both. By tailoring the degree and direction of distortion, or lack thereof, images can be printed on the ball such they appear undistorted on the ball.

Images printed according to methods described herein can comprise, but are not limited to logos, trademarks, technology names, alignment features (for example an alignment arrow or band), numerical images, non-numerical images, custom images, ball numbers, and other graphical images. In some embodiments, images printed according to methods described herein can be non-numerical images. A “non-numerical” image is an image that does not comprise a number.

Exemplary graphical image types for the images can comprise a basic geometrical shape, an animal character shape, a transportation object shape, a flag, a sports object shape, or a symbol. In some embodiments, the image can comprise only one of these graphical image types. In some embodiments, the image can comprise two or more of these graphical image types. For example, in some embodiments, the image can comprise a basic geometrical shape and an animal character shape.

Exemplary basic geometrical shapes for the images comprise a triangle, a quadrilateral, a polygon (e.g., a pentagon, a hexagon, a heptagon, etc.), a circle, an ellipse, a crescent, and a pill-shape.

Exemplary animal character shapes for the images comprise a bear, a bison, a camel, a cat, a dog, a cow, a cougar, a tiger, a lion, a donkey, a goat, a horse, a zebra, an elephant, a giraffe, a monkey, a gorilla, a hippopotamus, a hyena, a kangaroo, a bird, an owl, a penguin, a rabbit, a ram, a rhinoceros, a seal, a sheep, a turtle, a snake, a frog, a spider, a lizard, a fish, a dolphin, a shark, a duck, a rooster, a turkey, a chicken, and a pig.

Exemplary transportation object shapes for the images comprise a car, a truck, a train, an airplane, a subway car, a motorcycle, a bicycle, a boat, a jet ski, a tractor, submarine, and a rocket.

Exemplary flags for the images comprise a United States flag, a Canadian flag, a Mexican flag, a Great Britain flag, an Irish flag, a Scottish flag, a French flag, a Spanish flag, a Portuguese flag, a German flag, a Swiss flag, an Italian flag, a South African flag, a Chinese flag, a Japanese flag, and an Australian flag.

Exemplary sports object shapes for the images comprise a soccer ball, a baseball, a softball, a basketball, a tennis ball, a volleyball, a frisbee, a football, a golf club, a lacrosse stick, a hockey stick, a hockey skate, a baseball cap, a baseball bat, a skateboard, and a surf board.

Exemplary symbols for the images comprise a dollar sign, a maple leaf, a Greek letter, a smiley face, a peace sign, a ying-yang, a zodiac sign, a heart, a spade, and a musical note symbol.

Spherical balls, for example golf balls, according to embodiments described herein can comprise one or more images in the form of a logo, a trademark, a technology name, an alignment features (for example an alignment arrow or band), a custom image, a ball number, and any of the other graphical images described above. While various embodiments are described herein with reference to a golf ball, other spherical balls can comprise the single pass printed images described herein. Other exemplary spherical balls include, but are not limited to, lacrosse balls, soccer balls, pool balls, table tennis balls, baseballs, basketballs, and volleyballs. In some embodiments, images printed according to methods described herein can be printed on curved, but not spherical balls, such as footballs or rugby balls.

Golf balls according to embodiments described herein can comprise one or more single-pass-printed images. In particular embodiments, the golf balls according to embodiments described herein can comprise one or more images printed according to single pass printing methods described herein.

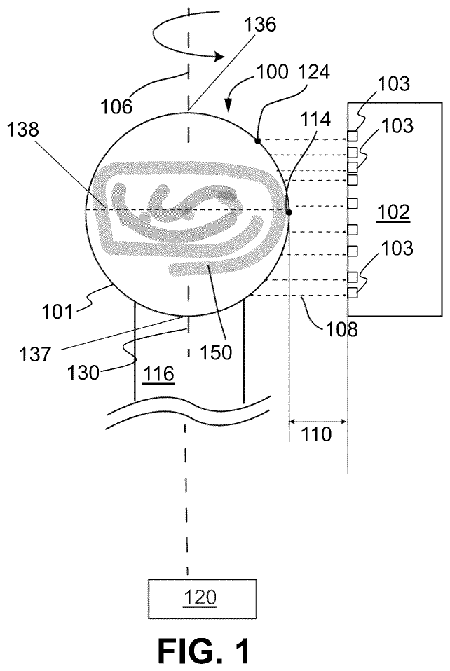

Referring now to the Figures, FIG. 1 illustrates a single pass printer head 102 and a golf ball 100 comprising a printed image 150 according to some embodiments. Ball 100 can be located on a ball holder 116. The ball holder 116 can be connected to a digital encoder 120 that tracks the precise orientation of the golf ball 100 while ball 100 rotates on a rotation axis 106. In some embodiments, ball holder 116 can rotate ball 100 on rotation axis 106. Image 150 can be any of the images descried herein, including but not limited to, images 600, 610, 620, and 630.

In some embodiments, rotation axis 106 can be a first central axis 130 of golf ball 100. In some embodiments, rotation axis 106 can be a second central axis 132 of golf ball 100. In some embodiments, rotation axis 106 can be the central axis of ball 100 that is perpendicular to the direction at which ink is ejected from nozzles 103 of printer head 102. In some embodiments, rotation axis 106 can be a central vertical axis of ball 100. In some embodiments, rotation axis 106 can be a central horizontal axis of ball 100.

For purposes of the present disclosure, ball 100 comprises at least the following two central axes: first central axis 130 and second central axis 132 perpendicular to the first central axis 130. In some embodiments, first central axis 130 can be a central vertical axis of ball 100 and second central axis 132 can be a central horizontal axis of ball 100. In some embodiments, first central axis 130 can be a central horizontal axis of ball 100 and second central axis 132 can be a central vertical axis of ball 100.

Relative to rotation axis 106, ball 100 comprises a first pole 136, a second pole 137 opposite the first pole 136 along a central axis of ball 100, and an equator 138 equidistant from the first pole 136 and the second pole 137. Rotation axis 106 can be an axis of ball 100 extending through the first pole 136 and the second pole 137 of the ball 100. In some embodiments, the first pole 136 can be a top pole of ball 100 and the second pole 137 can be a bottom pole of ball 100.

Golf ball 100 rotates on rotation axis 106 at a rate of rotation while ink droplets 108 are ejected from nozzles 103 of printer head 102. A throw distance 110 for the ink droplets is defined as the distance between the closest point 114 on the golf ball 100 and the closest point on the printer head 102. In other words, with a relatively flat printer head 102 and a golf ball 100, the throw distance 110 is the distance between the widest part of the golf ball 100 and the printer head 102, as shown for example in FIG. 1. In some embodiments, throw distance 110 can range from 0 millimeter (mm) to 10 mm, from 0.5 mm to 1.5 mm, from 0.1 mm to 7 mm, or from 0.1 and 5 mm. In some embodiments, throw distance 110 can range from 0 mm to 2 mm, from 0 mm to 1 mm, from 0.1 mm to 1 mm, or from 0.5 to 1 mm. In some embodiments, throw distance 110 can be about 0.8 mm.

The distance ink droplets 108 travel between the ball 100 and the printer head 102 increases or decreases depending on the curvature of the ball's surface at the particular location at which an ink droplet 108 is printed on the ball's surface. For example, at a second reference point 124 illustrated in FIG. 1 located away from the closest point 114, an ink droplet 108 will have to travel farther to reach the ball's surface.

In some embodiments, the rotation rate of golf ball 100 as it rotates on rotation axis 106 can range from 1 to 7 revolutions per second (rps) or from 60 revolutions per minute to 420 revolutions per minute (rpm). In some embodiments, the revolutions per second can range from 2 to 3 rps, from 0.1 rps to 1 rps, or from 0.2 rps to 0.5 rps. In some embodiments, the rotation rate can range from 1 rpm to 400 rpm, from 10 rpm to 300 rpm, from 50 rpm to 320 rpm, from 80 rpm to 180 rpm, or from 120 rpm to 180 rpm. In some embodiments, ball 100 can rotate on rotation axis 106 at a rate of about 160 rpm. In some embodiments, ball 100 can rotate on rotation axis 106 at a rate ranging from 100 rpm to 200 rpm.

In some embodiments, the ball rotation rates described herein can be for a ball circumference of about 13.4 cm and a ball diameter ranging from 1.678 inches (42.6 mm) to 1.688 inches (42.9 mm). In some embodiments, the ball diameter can be 1.683 inches (42.7 mm) with a plus or minus tolerance of 0.005 inches (0.127 mm).

In some embodiments, ball 100 can comprise a diameter ranging from 1.678 inches (42.6 mm) to 1.688 inches (42.9 mm). In some embodiments, the ball 100 can comprise a diameter of 1.683 inches (42.7 mm) with a plus or minus tolerance of 0.005 inches (0.127 mm). In some embodiments, ball 100 can comprise a diameter ranging from 42 mm to 43 mm.

In some embodiments, the print rate or scan rate of the printer head 102 can range from 10 cm/s (centimeters per second) to 100 cm/s, from 60 cm/s to 90 cm/s, or from 75 cm/s and 85 cm/s. The print rate or scan rate is how quickly the printer head 102 can print an image on a surface without seeing significant distortions in the image.

In some embodiments, the dispense rate or the velocity of ink droplets ejected from nozzles 103 can range from 2 m/s (meters per second) to 10 m/s, from 3 m/s to 9 m/s, from 4 m/s to 8 m/s, or from 5 m/s to 7 m/s.

In some embodiments, the volume of a single ink droplet 108 ejected from nozzles 103 can range from 6 to 160 picoliters, from 0 to 200 picoliters, from 50 to 150 picoliters, from 6 to 42 picoliters, from 12 to 84 picoliters, from 40 to 160 picoliters, or from 75 to 125 picoliters. In some embodiments, the volume of a single ink droplet 108 ejected from nozzles 103 can range from 6 to 36 picoliters, from 12 to 36 picoliters, from 18 to 36 picoliters, from 24 to 36 picoliters, from 30 to 36 picoliters, from 6 to 30 picoliters, from 6 to 24 picoliters, from 6 to 18 picoliters, or from 6 to 12 picoliters. In some embodiments, the volume of a single ink droplet 108 ejected from nozzles 103 can range from 6 to 48 picoliters, from 12 to 48 picoliters, from 18 to 48 picoliters, from 24 to 48 picoliters, from 30 to 48 picoliters, from 36 to 48 picoliters, or from 6 to 42 picoliters.

Each ink droplet 108 printed by nozzles 103 can correlate to a pixel for a printed image 150 on ball 100. Pixels are digital information used by a single pass printing system comprising printer head 102 to print an image 150 on ball 100. The system can convert pixels for an image 150 into dots that correspond to ink droplets 108 printed by print head 102. Each pixel can comprise one or more ink droplets 108 printed by print head 102.

As described herein, in some embodiments, the ink droplets 108 for an image 150 can be printed based on a pixel map (for example, pixel map 700′ or pixel map 710′) comprising pixel areas corresponding with pixels for an image. In some embodiments, the ink droplets 108 for an image 150 can be printed based on a pixel map (for example, pixel map 700′ or pixel map 710′) comprising pixel areas having a one-to-one correspondence with pixels for an image. A pixel map can comprise a plurality of undistorted pixel areas, a plurality of distorted pixel areas distorted in at least one of a width direction and a height direction, or a plurality of both undistorted pixel areas and distorted pixel areas. In some embodiments, the ink droplets 108 for an image 150 can be printed based on an undistorted pixel map devoid of distorted pixel areas.

In some embodiments, the resolution of the printed image 150 on golf ball 100 can range from 100 to 1400 dots per inch (dpi), from 200 dpi to 400 dpi, from 300 dpi to 400 dpi, from 320 dpi to 390 dpi, from 1000 dpi to 1300 dpi, from 350 dpi to 370 dpi, from 700 dpi to 800 dpi, or from 740 dpi to 780 dpi. In some embodiments, the resolution of the printed image 150 on the golf ball 100 can be at least 360 dpi. In some embodiments, the resolution of the printed image 150 on the golf ball 100 can be about 360 dpi. In some embodiments, the resolution of the printed image 150 on the golf ball 100 can be at least 760 dpi. In some embodiments, the resolution of the printed image 150 on the golf ball 100 can be about 760 dpi. In some embodiments, the resolution of the printed image 150 on the golf ball 100 can range from about 360 dpi to about 760 dpi.

In some embodiments, the firing frequency for nozzles 103 of the printer head 102 can range from 6 to 12 kHz.

The one or more images 150 can be located on a surface 101 of ball 100. In some embodiments, the one or more images 150 can be located on a visible surface of ball 100. In some embodiments, the one or more images 150 can be located on an outer surface of the golf ball 100. In some embodiments, the one or more images 150 can be located below the outer surface of the golf ball 100. For example, in some embodiments, the golf ball 100 can include a dimpled surface and a protective coating layer disposed on the dimpled surface and defining the outer surface of the golf ball 100. In such embodiments, the one or more images 150 can be located on the dimpled surface covered by the protective coating layer.

In some embodiments, golf ball 100 can be pre-treated to apply a charge to the surface on which the one or more images 150 is to be printed to improve ink adhesion. Some examples of pre-treatment methods include corona discharge, flame, or plasma pre-treatment.

In some embodiments, the one or more images 150 can be printed using a UV curable ink. In such embodiments, at least one UV pinning operation can be used to pre-cure the UV curable ink before a final UV curing operation.

As discussed above, one or more images 150 can be printed on the ball 100 with a plurality of nozzles 103 while the ball 100 is rotating, for example on axis 106. In some embodiments, nozzles 103 can comprise a vertical array of nozzles 103.

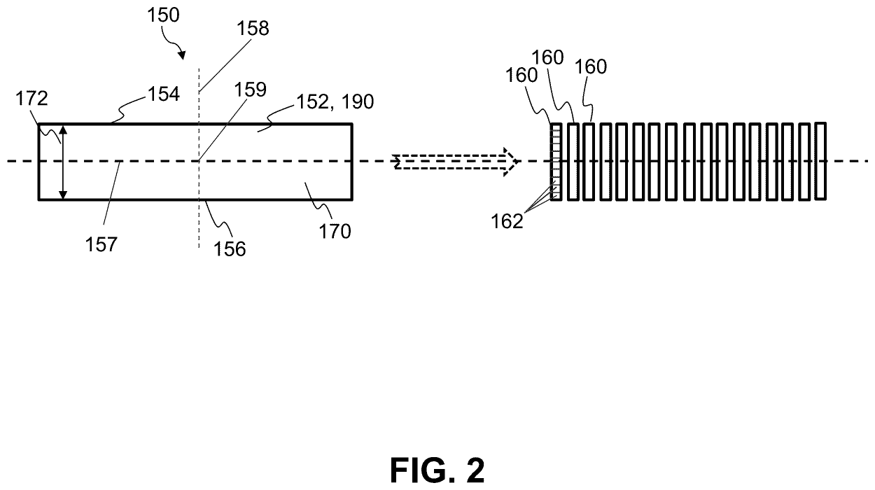

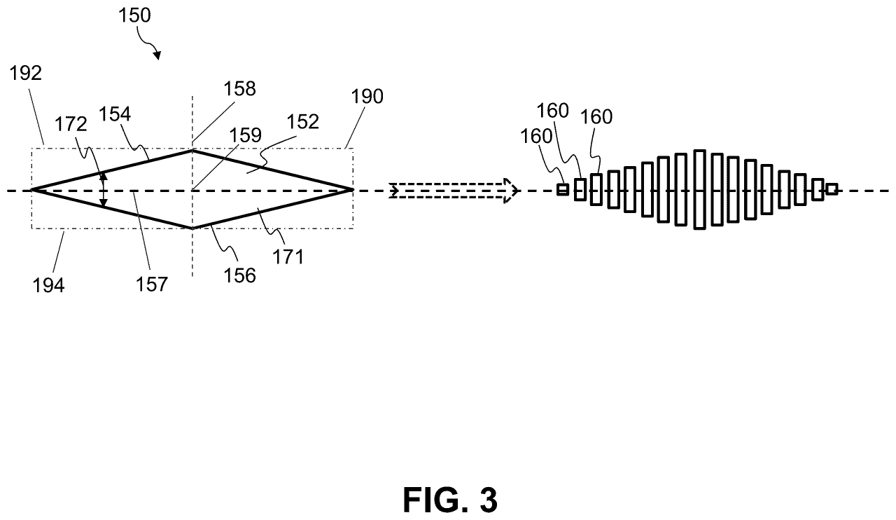

Referring now to FIGS. 2 and 3, when printing an image 150 on the ball 100, the image 150 can be defined by an image area profile 152 on the ball 100 comprising a top boundary line 154 and a bottom boundary line 156. Image area profile 152 can comprise, for example, a logo, a trademark, a technology name, and alignment feature (for example an alignment arrow or band), a custom image, a ball number, a graphical image, or a combination thereof.

The top boundary line 154 for image area profile 152 is the line defining the shape of the image area profile 152 at the edge defining a top half of the image area profile 152. Similarly, bottom boundary line 156 for image area profile 152 is the line defining the shape of the image area profile 152 at the edge defining a bottom half of the image area profile 152. Together, the top boundary line 154 and the bottom boundary line 156 define the perimeter shape of the image area profile 152. The image area profile 152 generally refers to the region that is bounded by an outer perimeter that may form a silhouette area where the image is located but may not necessarily have printed ink throughout the entire image area profile 152. The image area profile 152 may contain printed image 150 and negative space that is not printed at all but is still an integral part of the overall image area profile 152.

For example, the image 170 illustrated in FIG. 2, has a rectangular perimeter shape defined by top boundary line 154 and bottom boundary line 156. As another example, image 171 illustrated in FIG. 3, has a diamond-shaped perimeter defined by top boundary line 154 and bottom boundary line 156.

Image area profile 152 also comprises a vertical center line 158. As used herein, the center line for an image area profile 152 is defined as a line extending in the direction of rotation axis 106 and located at the center of the image area profile's maximum width.

Image areas profile 152 can be located within an image boundary area 190. An image boundary area 190 is a rectangular area encompassing the image area profile, comprising a height defined by the maximum height of the image area profile 152, and a width defined by the maximum width of the image area profile 152. For a rectangular image area profile, as shown for example in FIG. 2, image boundary area 190 is the same as image area profile 152. For a non-rectangular image area profile, as shown for example in FIG. 3, image boundary area 190 will not be the same as image area profile 152. Image boundary area 190 can comprise a top edge 192 and a bottom edge 194.

The vertical center line 158 of image area profile 152 is the vertical center line of image boundary area 190. A horizontal center line 157 of image boundary area 190 is defined as a line extending perpendicular to vertical center line 158 and located at the center of the height of an image boundary area 190. Image boundary area can also comprise a geometrical center 159 (also known as a centroid). Image boundary areas 190 do not necessary form a part of an image 150. Rather, the image boundary area 190 is an imaginary rectangular boundary encompassing an image area profile 152.

The image 150 defined by image area profile 152 can be printed by printing ink droplets 108 correlating to pixels 162 arranged in consecutive image lines 160 as the ball 100 rotates. Each image line 160 is defined by a plurality of pixels disposed between the top boundary line 154 and the bottom boundary line 156 of the image area profile 152. Each pixel 162 in each image line 160 correlates to one or more ink droplets 108 printed by one of the respective nozzles 103 of printer head 102. Each image line 160 can be disposed between the top boundary line 154 and the bottom boundary line 156 in a straight line in the direction of the height (for example, image height 172) of image area 152. For an image comprising a continuous printed region extending from the top boundary line 154 to the bottom boundary line 156, image line(s) 160 for the image can comprise a continuous line of pixels 162 extending from the top boundary line 154 to the bottom boundary line 156. For an image comprising one or more negative spaces that are not printed but are still an integral part of the overall image area profile 152, image lines(s) 160 for the image can comprise a discontinuous line of pixels 162 extending from the top boundary line 154 to the bottom boundary line 156, with missing pixels in the negative space(s).

In some embodiments, pixels 162 defining an image line 160 can comprise the same color pixels. In some embodiments, pixels 162 defining an image line 160 can comprise different color pixels.

As illustrated for example in FIG. 2, image 170 can be printed by printing droplets 108 correlating to pixels 162 in consecutive image lines 160. Similarly, as illustrated in FIG. 3, image 171 can be printed by printing droplets 108 correlating to pixels 162 in consecutive image lines 160. The image height of an image area profile 152 (for example, image height 172) at any particular image line 160 is defined by the distance between the top boundary line 154 and bottom boundary line 156 along the particular image line 160.

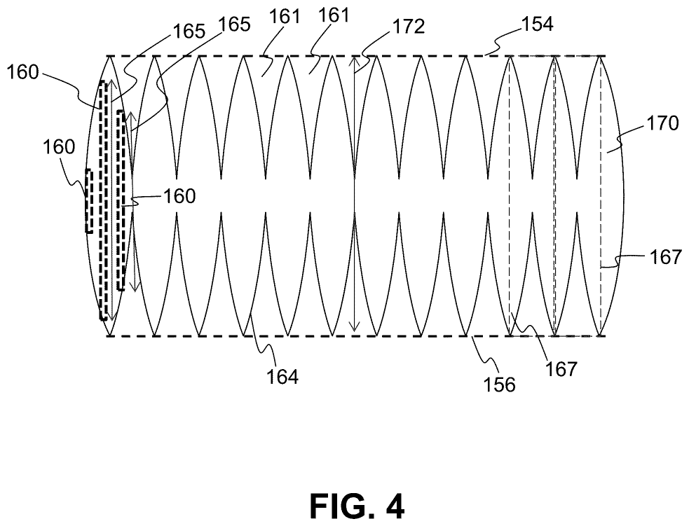

In some embodiments, the number of pixels 162 in image lines 160 can be based on a curvature of the surface of ball 100. In such embodiments, due to the curvature, the desired image area profile 152 can be printed based on a flat representation of the image comprising image lines 160 that take into account the ball's curvature. In such embodiments, the flat representation can comprise a distorted or undistorted pixel map as described herein. For example, to print image 170 having a constant image height 172 on ball 100, the image area profile 152 for image 170 can be printed based on flat representation 164 of the image illustrated in FIG. 4. By printing the image area profile 152 based on a flat representation 164 of the image and printing droplets correlating to pixels in image lines 160 based on the flat representation 164 of the image, image distortion due to the curvature of the ball's surface can be limited or avoided when the image is actually printed on the golf ball.

In some embodiments, a flat representation for an image area profile 152 can comprise select pixels removed such that the flat representation comprises a plurality of image lines 160 having an image line height 165 less than the image height 172 of an image area profile 152 on the ball 100 at locations corresponding to the respective image lines 160 on ball 100. Arranging image lines 160 comprising a plurality of image lines 160 having an image line height 165 less than the height 172 on ball 100 can result in a flat representation 164 of the image comprising open spaces 161, as shown for example in FIG. 4.

In some embodiments, pixels 162 can be removed at regular intervals such that pixels 162 are arranged in image lines 160 having image line heights 165 that vary in regular intervals 167 relative to height 172 of an image area profile 152, as shown for example in FIG. 4. In some embodiments, pixels 162 can be removed at irregular intervals such that pixels 162 are arranged in image lines 160 having image line heights 165 that vary in irregular intervals relative to image height 172 of an image area profile 152.

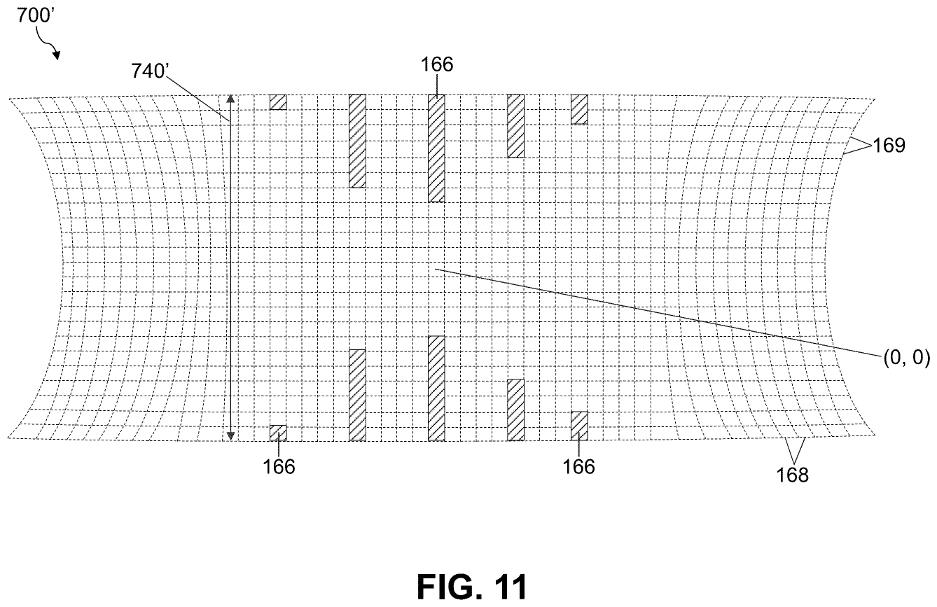

In some embodiments, a pixel map as described herein can comprise pixel areas removed as described above. For example, FIG. 11 shows pixel map 700′ comprising removed pixel areas 166 according to some embodiments. In such embodiments, the pixel map can comprise pixel area lines 168 having a height less a height 740′ of a pixel map at locations corresponding to respective pixel area lines 168 had the pixel areas not been removed. Pixel areas of a pixel map can be removed at regular or irregular intervals.

In addition to comprising a plurality of image lines 160 having an image line height 165 less than the image height 172 of an image area profile 152, the flat representation 164 can comprise one or more image lines 160 having an image line height 165 equal to the image height 172 of an image area profile 152 at a location corresponding to the image line 160 on ball 100. Similarly, a pixel map as described herein can comprise one or more pixel area lines 168 having a height equal to the height 740′ of a pixel map at locations corresponding to respective pixel area lines 168.

As shown in FIG. 4, image 170 having a constant image height 172 can be printed based on a flat representation 164 of the image comprising consecutive image lines 160 having a different number of pixels, thereby creating image lines 160 having different heights 165. FIG. 4 shows some exemplary image lines 160 for illustration purposes. When ink droplets correlating to the consecutive image lines 160 having the different number of pixels are printed on ball 100, image 170 having a constant height 172 will appear on the ball's surface. Similarly, for an image 170 having a constant image height 172, the pixel map for that image can comprise pixel area lines 168 having a different number of pixel areas, thereby creating pixel area lines 168 having different heights. When ink droplets correlating to the consecutive pixel area lines 168 having the different number of pixel areas are printed on ball 100, image 170 having a constant height 172 will appear on the ball's surface. While FIG. 4 shows a flat representation 164 for a constant-height image 170, it is appreciated that any image area profile can be similarly printed based on a flat representation 164 of the image (for example, a pixel map) for purposes of single pass printing a curved ball surface as described herein.

In some embodiments, an image area profile 152 can be distorted based on a distorted pixel map and then pixel areas can be removed from the pixel map. In some embodiments, an image area profile 152 can be simultaneously distorted based on a distorted pixel map while pixels or pixel areas are removed. By distorting an image area profile 152 based on a pixel map as described herein, image distortion resulting from removing pixels or pixel areas as described herein can be can be limited or avoided when the image is actually printed on the golf ball.

Images 150 printed according to embodiments described herein can be printed using a method comprising the following steps. First, an image 150 can applied to an undistorted pixel map to create a pixelated image area profile for the image 150. The undistorted pixel map comprises undistorted pixels 162 arranged in image lines 160 for an image area profile 152 as described above. In some embodiments, image 150 can be applied to an undistorted pixel map before being sent to a single pass printing system comprising printer head 102. In some embodiments, a single pass printing system comprising printer head 102 can apply an image 150 to an undistorted pixel map. In either case, graphical printing software can be used to convert an image 150 to an image area profile 152 comprising image lines 160.

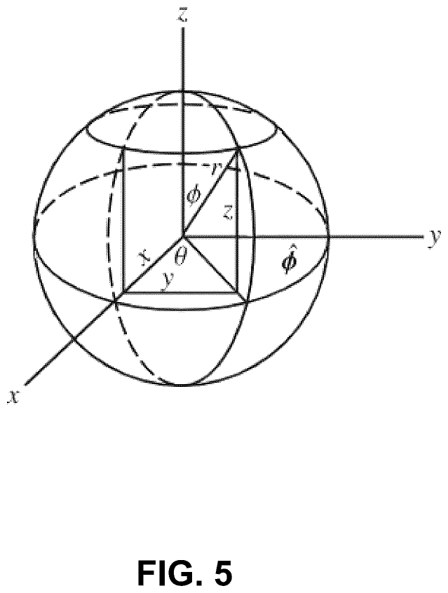

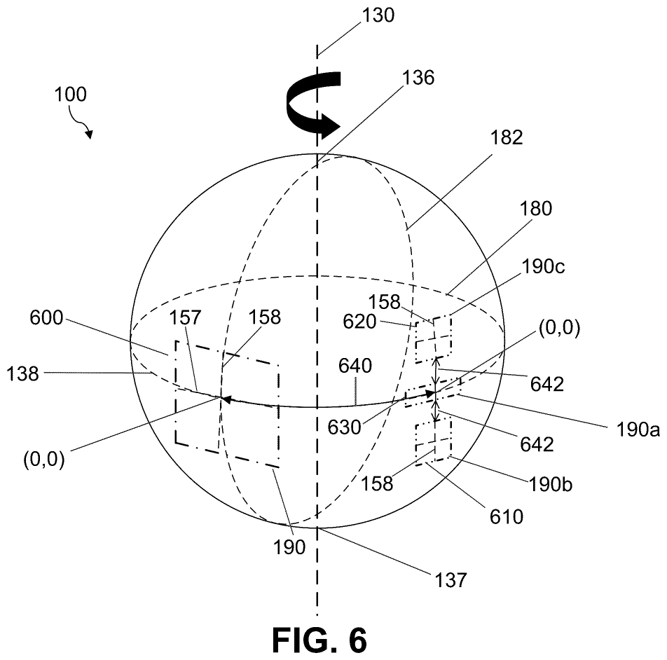

Before or after creating image area profile 152, the print location of the image 150 on the surface of ball 100 can be determined. In some embodiments, the print location can be based on a center point of the image area profile 152. In some embodiments, the center point of the image area profile 152 can be the geometrical center 159 of an image boundary area 190. For purposes of this disclosure, as illustrated in FIG. 5, a point or location on the surface of ball 100 (for example, center locations or center points for image area profiles 152 or pixels 162) are defined by Cartesian coordinates in a polar coordinate system where: r is the radius of the ball in millimeters, the x-y plane is defined by a first central plane (for example, central plane 180 of the ball 100 shown in FIG. 6) perpendicular to a central axis of a ball 100, and the x-z plane is defined by a second central plane (for example, central plane 182 of the ball 100 shown in FIG. 6) perpendicular to the first central plane.

As known, the spherical coordinates (r, θ, ϕ) are related to the Cartesian coordinates (x, y, z) by the following equations.

$$r = \sqrt{{x}^{2} + {y}^{2} + {z}^{2}} \qquad ( Equation 1 )$$

$$θ = {tan}^{- 1} ( \frac{y}{x} ) \qquad ( Equation 2 )$$

$$ϕ = {cos}^{- 1} ( \frac{z}{r} ) \qquad ( Equation 3 )$$

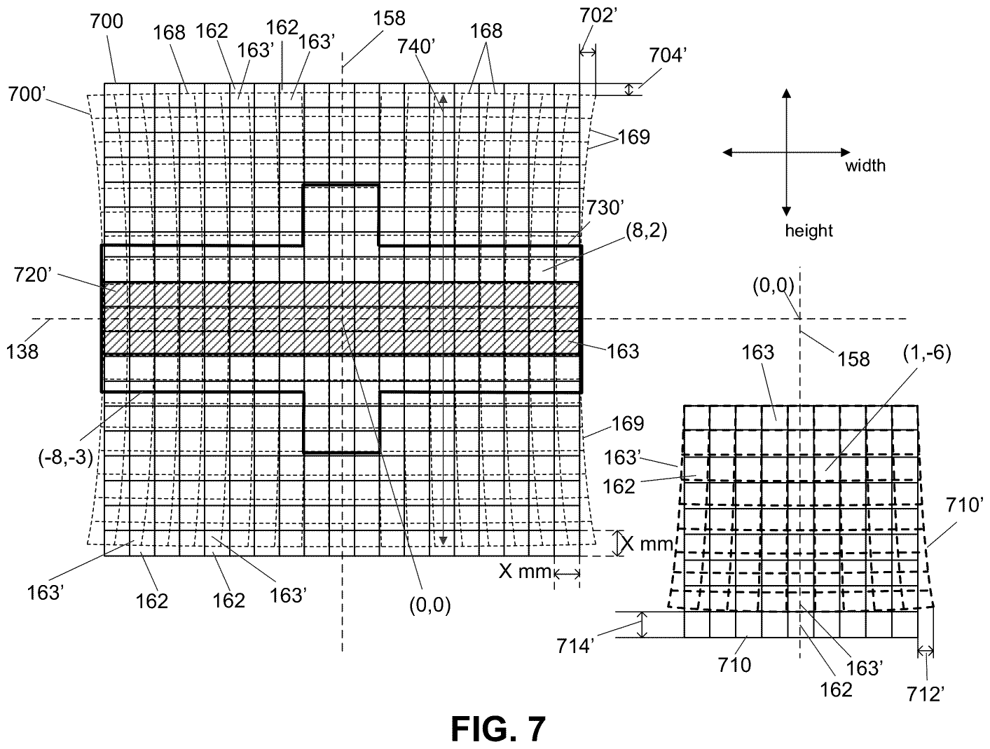

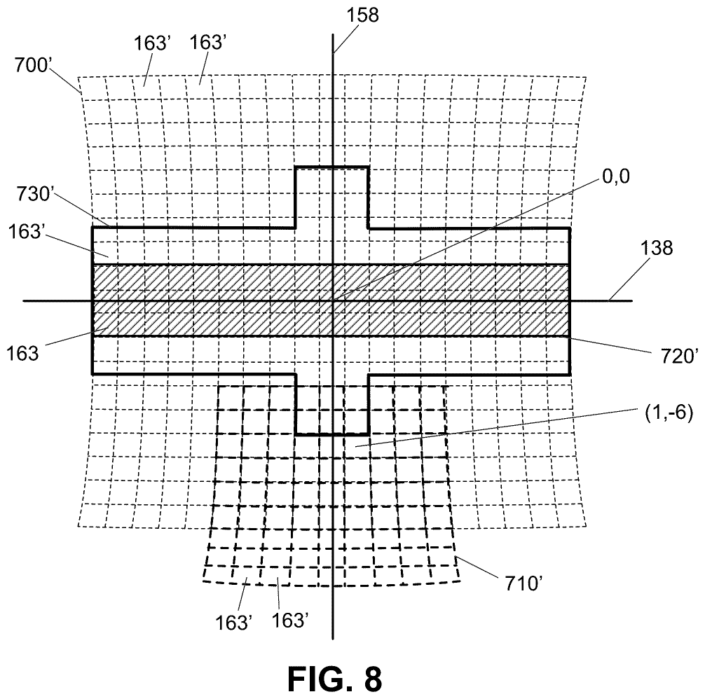

Based on the print location of the image area profile 152, the pixels 162 of the image area profile 152 can be pre-distorted based on a distorted pixel map (for example, distorted pixel map 700′ or 710′ shown in FIGS. 7 and 8) comprising a plurality of distorted pixel areas 163′ to create a distorted pixelated image area profile for the image 150. In some embodiments, the distorted pixel map can comprise a plurality of undistorted pixel areas 163 and a plurality of distorted pixel areas 163′. Distorted pixel areas 163′ can be distorted in at least one of a width direction and a height direction. In some embodiments, distorted pixel areas 163′ can be distorted in both the width direction and the height direction.

In some embodiments, image 150 can be pre-distorted before being sent to a single pass printing system comprising printer head 102. In such embodiments, the distorted pixelated image area profile can be supplied to a single pass printer that prints the image 150 on a surface of the ball 100. In some embodiments, a single pass printing system comprising printer head 102 can pre-distort the image before printing. In either case, the metrics for distorting pixel areas for a distorted pixel map can be programed into software configured to distort pixel areas based on an undistorted pixel map and the print location for an image area profile 152 on ball 100. In some embodiments, the distortion of a pixel map can occur by modifying existing pixel sizes to either contract or stretch the pixel in either the height or width direction. In some embodiments, the distortion of a pixel map can occur by modifying existing pixel sizes to either contract or stretch the pixel in either the height or width direction and by removing select pixels within the pixel map.

During or after pre-distorting the image area profile 152, pixels 162 or pixel areas 163, 163′ can be selectively removed from the distorted pixelated image area profile. By removing certain pixels 162 or pixel areas 163, 163′, at least one or a plurality of pixels/pixel areas located near the deleted pixels/pixel areas can be distorted to accommodate any new desired pixel layout. FIG. 11 illustrates an exemplary pixel map 700′ comprising removed pixel areas 166 according to some embodiments. In some embodiments, rather than remove pixel areas 163, 163′, pixels 162 can be removed before any distortion is applied to other pixels 162 to create distorted pixel areas 163′.

After pre-distorting the image area profile 152 and removing select pixels/pixel areas, image 150 can be single-pass-printed on the surface of ball 100 based on the distorted pixelated image area profile with the select pixels/pixel areas removed while the ball is rotating on a central axis of the ball. By printing the pre-distorted image area profile 152, a single pass printing system prints ink droplets 108 correlating to pixel areas of the distorted pixel map with the select pixels/pixel areas removed.

For purposes of generating a distorted pixel map for an image 150, the center point (i.e., the (0, 0) point) is defined by a localized Cartesian coordinate system. The localized Cartesian coordinate system for an undistorted pixel map, and the corresponding distorted pixel map, is defined by the intersection of the ball's equator 138 and the vertical center line 158 of an image area profile 152 for image 150. For example, FIG. 6 shows the center point (0, 0) for images 600, 610, 620, and 630. The center point (0, 0) for images 610, 620, and 630 is the same because the vertical center line for these images is at the same location.

The center point (i.e., the (0, 0) point) in the localized Cartesian coordinate system for an undistorted pixel map, and any location within the undistorted pixel map (for example, the center location of each pixel 162 in the map), is represented by the Y-coordinate and the Z-coordinate in the localized Cartesian coordinate system. The Y-coordinate can be positive or negative relative to the center point. Similarly, the Z-coordinate can be positive or negative relative to the center point. FIG. 7 shows exemplary locations (8, 2), (−8, −3), and (1, −6). The (8, 2) location has a Y-coordinate of 8 and a Z-coordinate of 2. The (−8, −3) location has a Y-coordinate of −8 and a Z-coordinate of −3. The (1, −6) location has a Y-coordinate of 1 and a Z-coordinate of −6. The (8, 2) and (−8, −3) locations for map 700 in FIG. 7 are located relative to the center point (i.e., the (0, 0) point) for map 700. The (1, −6) location for map 710 in FIG. 7 is located relative to the center point (i.e., the (0, 0) point) for map 710.

As illustrated in FIG. 7, the Y-axis of the Cartesian coordinate system can correspond to a width direction of a pixel map and the Z-axis of the Cartesian coordinate system can correspond to a height direction of the pixel map.

This localized Cartesian coordinates system can be used by a single pass printing system to print ink print droplets 108 correlated to pixels 162 or pixel areas 163, 163′ for an image 150 on ball 100. While this localized Cartesian coordinate system locates each image 150 relative to its own center point (0, 0), the single pass printing system can also comprise information related to the absolute location of an image on ball 100 in a full Cartesian coordinate system for ball 100 as discussed above. In such embodiments, the absolute location of the image(s) on ball 100 can be programmed into the software of the single pass printing system. In some embodiments, the absolute location can be converted to the localized Cartesian coordinate system for an image area profile 152 based on the intended location of the vertical center line 158 of an image 150.

Any number of images 150 can be printed on ball 100 using the single pass printing methods as described herein. Each image 150 can be printed by printing ink droplets correlating to pixels 162 arranged in consecutive image lines 160 defined by a plurality of the pixels 162 disposed between a top boundary line 154 and a bottom boundary line 156 and comprising at least one of the ink droplets that forms the image. And the ink droplets of each image 150 can be printed based on a pixel map comprising pixel areas corresponding with pixels 162 of the image area profile 152. In some embodiments, a pixel map can comprise pixel areas having a one-to-one correspondence with pixels 162 of the image area profile 152. In some embodiments, the pixel map can comprise a plurality of distorted pixel areas distorted in at least one of a width direction and a height direction. In some embodiments, the pixel map can comprising a plurality of undistorted pixel areas. In some embodiments, pixel map can be an undistorted pixel map comprising only undistorted pixel areas.

FIG. 6 shows a ball 100 comprising a first image 600, a second image 610, a third image 620, and a fourth image 630. In some embodiments, first image 600 can be a first non-numerical image. In some embodiments, second image 610 can be a non-numerical image. In some embodiments, third image 620 can be a non-numerical image. In some embodiments, fourth image 630 can be a non-numerical image. In some embodiments, fourth image 630 can be a manufacture's logo.

In some embodiments, fourth image 630 comprising the manufacture's logo can be within an image boundary area located on the equator 138. In some embodiments, fourth image 630 comprising the manufacture's logo can be defined based on an undistorted pixel map for the manufacturer's logo. In some embodiments, fourth image 630 comprising the manufacture's logo can be defined based on a distorted pixel map for the manufacturer's logo comprising no more than 10% distorted pixel areas distorted in at least one of a width direction and a height direction.

In some embodiments, a ball 100 can comprise a fifth image located 180° from first image 600. In some embodiments, a ball 100 can comprise a sixth image located 180° from second image 610. In some embodiments, a ball 100 can comprise a seventh image located 180° from third image 620. In some embodiments, a ball 100 can comprise an eighth image located 180° from fourth image 630. In some embodiments, the eighth image can be a manufacture's logo.

In some embodiments, the eighth image comprising the manufacture's logo can be within an image boundary area located on the equator 138 and can be defined based on an undistorted pixel map for the manufacturer's logo. In some embodiments, the eighth image comprising the manufacture's logo can be defined based on a distorted pixel map for the manufacturer's logo comprising no more than 10% distorted pixel areas distorted in at least one of a width direction and a height direction.

In some embodiments, a vertical center line 158 of the image boundary area 190 for image 630 can be separated from a vertical center line 158 of the image boundary area 190 for the eighth image by an arc distance 640 ranging from 65 mm to 70 mm. In some embodiments, a vertical center line 158 of the image boundary area 190 for image 630 can be separated from a vertical center line 158 of the image boundary area 190 for the eighth image by an arc distance 640 equal to about 50% of a circumference of the ball.

In some embodiments, the vertical center line 158 of first image 600 can be separated from the vertical center line 158 of second image 610 by an arc distance 640 ranging from 30 mm to 35 mm. In some embodiments, the vertical center line 158 of first image 600 can be separated from the vertical center line 158 of third image 620 by an arc distance 640 ranging from 30 mm to 35 mm. In some embodiments, the vertical center line 158 of first image 600 can be separated from the vertical center line 158 of fourth image 630 by an arc distance 640 ranging from 30 mm to 35 mm.

In some embodiments, the vertical center line 158 of first image 600 can be separated from the vertical center line 158 of second image 610 by an arc distance 640 equal to about 25% of a circumference of the ball. In some embodiments, the vertical center line 158 of first image 600 can be separated from the vertical center line 158 of third image 620 by an arc distance 640 equal to about 25% of a circumference of the ball. In some embodiments, the vertical center line 158 of first image 600 can be separated from the vertical center line 158 of fourth image 630 by an arc distance 640 equal to about 25% of a circumference of the ball.

In some embodiments, a center location of image 600 (and therefore the center location of image area profile 152 for image 600) can be located on the first central plane 180 of ball 100. In some embodiments, the center location can be the geometrical center 159 of the image boundary area 190 for image 600. As discussed above, first central plane 180 can be the x-y plane of the Cartesian coordinates system.

In some embodiments, a center location of image 610 (and therefore the center location of image area profile 152 for image 610) can be located below the first central plane 180 of ball 100. In some embodiments, the center location can be the geometrical center 159 of the image boundary area 190 for image 610.

In some embodiments, a center location of image 620 (and therefore the center location of image area profile 152 for image 620) can be located above the first central plane 180 of ball 100. In some embodiments, the center location can be the geometrical center 159 of the image boundary area 190 for image 620.

In some embodiments, a center location of image 630 (and therefore the center location of image area profile 152 for image 620) can be located on the first central plane 180 of ball 100. In some embodiments, the center location can be the geometrical center of the image boundary area 190 for image 630.

In some embodiments, image 630 can comprise a manufacture's logo extending along the first central plane 180 on surface 101 of ball 100. In some embodiments, image 610 can be located below the manufacture's logo on the ball 100. In some embodiments, a top boundary line 154 of image area profile 152 for image 610 can be separated from a bottom of the manufacture's logo by an arc distance 642 ranging from 1 mm to 4 mm. In some embodiments, a top boundary line 154 of image area profile 152 for image 610 can be separated from a bottom of the manufacture's logo by an arc distance 642 ranging 1 mm to 6 mm.

In some embodiments, image 630 can comprise a manufacturer's logo within a first image boundary area 190a located on the equator 138. In some embodiments, the manufacturer's logo can be defined based on an undistorted pixel map for the manufacturer's logo. In some embodiments, the manufacturer's logo can be defined based on a distorted pixel map for the manufacturer's logo.

In some embodiments, image 610 can be within a second image boundary area 190b located adjacent the first image area profile, wherein the image 610 is defined based on a distorted pixel map for the image.

In some embodiments, a horizontal center line 157 of the first image boundary area 190a can be located on the equator 138. In some embodiments, a top edge 192 of the second image boundary area 190b can be separated from a bottom edge 194 of the first image boundary area 190a by an arc distance 642 ranging from 1 mm to 4 mm. In some embodiments, the top edge 192 of the second image boundary area 190b can be separated from the bottom edge 194 of the first image boundary area 190a by an arc distance 642 ranging from 1 mm to 6 mm.

In some embodiments, image 620 can be within a third image boundary area 190c located adjacent the first image boundary area 190a, wherein the image is defined based on a distorted pixel map for the image.

In some embodiments, a bottom edge 194 of the third image boundary area 190c can be separated from a top edge 192 of the first image boundary area 190a by an arc distance 642 ranging from 1 mm to 4 mm. In some embodiments, a bottom edge 194 of the third image boundary area 190c can be separated from a top edge 192 of the first image boundary area 190a by an arc distance 642 ranging from 1 mm to 6 mm.

In some embodiments, the sixth image can be located adjacent the eighth image in the same manner as described herein for fourth image 630 and second image 610. In some embodiments, the seventh image can be located adjacent the eighth image in the same manner as described herein for fourth image 630 and third image 620.

As used herein, a “pixel map” is a flat representation of an image area profile 152 comprising pixels 162 or pixel areas 163, 163′ representing digital information used by a single pass printing system comprising printer head 102 to print droplets 108 for an image 150 on ball 100. An undistorted pixel map comprises image lines 160 as described herein. In some embodiments, the undistorted pixel map can comprise information related to the location of each pixel 162 within the image lines 160 relative the center point (0, 0) of an image in the localized Cartesian coordinate system discussed above. Pixel maps can comprises pixel area lines 168 defined by pixel areas corresponding to pixels 162 having the same Y-coordinate value. Pixel maps can comprises pixel area rows 169 defined by pixel areas corresponding to pixels 162 having the same Z-coordinate value.

An undistorted pixel map comprises only undistorted pixels. The pixels 162 of the undistorted pixel map all have the same base geometry (for example, a square or a rectangle) and perimeter dimensions. As used herein, an undistorted pixel 162 or pixel area 163 is (i) a pixel (or pixel area) in a group of pixels (or pixel areas) that have the same base geometry and perimeter dimensions or (ii) a pixel (or pixel area) in a group of pixels (or pixel areas) that all have the same base geometry and perimeter dimensions with no more than a 0.1% distortion of a perimeter dimension in a width direction, a height direction, or both. As a non-limiting example, undistorted pixel maps 700 and 710 shown in FIG. 7 comprise only undistorted pixel areas 163 in the form squares having a height and width of X mm. Solely for illustration purposes, FIG. 7 shows pixel map 700 comprising a 19×19 grid of pixels and pixel map 710 comprising a 9×9 grid of pixels. However, it should be appreciated that pixelated images areas and pixel maps for an image can comprise any number of pixels. The number of pixels can be based on the desired size and resolution of an image.

In some embodiments, pixels 162 (and undistorted pixel areas 163) can comprise a height ranging from 0.01 mm to 1 mm, including subranges. For example, pixels 162 (and undistorted pixel areas 163) can comprise a height ranging from 0.01 mm to 1 mm, from 0.01 mm to 0.5 mm, from 0.01 mm to 0.1 mm, from 0.01 mm to 0.05 mm, from 0.05 mm to 1 mm, or from 0.05 mm to 0.1 mm. In some embodiments, pixels 162 (and undistorted pixel areas 163) can comprise a width ranging from 0.01 mm to 1 mm, including subranges. For example, pixels 162 (and undistorted pixel areas 163) can comprise a width ranging from 0.01 mm to 1 mm, from 0.01 mm to 0.5 mm, from 0.01 mm to 0.1 mm, from 0.01 mm to 0.05 mm, from 0.05 mm to 1 mm, or from 0.05 mm to 0.1 mm.

A distorted pixel map comprises distorted pixel areas 163′ that are (i) distorted relative to a corresponding undistorted pixel 162 in an undistorted pixel map and (ii) have at least one dimension distorted based on the center location of the pixel 162 in the corresponding undistorted pixel map defined by the localized Cartesian coordinates discussed above. For example, FIG. 7 shows two exemplary distorted pixel maps 700′ and 710′ comprising distorted pixel areas 163′.

In some embodiments, a distorted pixel map can comprise a plurality of undistorted pixel areas 163 and plurality of distorted pixel areas 163′. Undistorted pixel areas 163 for a pixel map can correspond directly to pixels 162 in image lines 160 with no distortion, or with no more than a 0.1% distortion of a perimeter dimension in a width direction, a height direction, or both.

The degree and direction of distortion for each distorted pixel area 163′ of a distorted pixel map can account for the curvature of the surface of ball 100 by distorting pixel areas 163′ based on the center location of the pixel 162 in the corresponding undistorted pixel map. By tailoring the degree and direction of distortion, or lack thereof, and removing select pixel areas as described herein, images 150 can be printed on ball 100 such they appear undistorted on the surface of the ball 100.

In some embodiments, a distorted pixel map (for example, maps 700′ and 710′) can comprise an undistorted area 720′. In some embodiments, undistorted area 720′ can comprise only undistorted pixel areas 163. In some embodiments, at least 90% of the pixel areas within undistorted area 720′ are undistorted pixel areas 163.

In some embodiments, undistorted area 720′ can be defined by an area within the localized Cartesian coordinate system having a first maximum Z-coordinate value of Z1 and a first minimum Z-coordinate value of −Z1. In some embodiments, Z1 can be 1 mm, 1.5 mm, 2 mm, 2.5 mm, or 3 mm. In some embodiments, −Z1 can be −1 mm, −1.5 mm, −2 mm, −2.5 mm, or −3 mm. In some embodiments, Z1 can range from 1 mm to 3 mm, or from 1 mm to 2 mm. In some embodiments, −Z1 can range from −1 mm to −3 mm, or from −1 mm to −2 mm.

In embodiments comprising undistorted area 720′, pixel areas having a center location located between the maximum Z-coordinate value (Z1) and the minimum Z-coordinate value (−Z1) can be undistorted pixel areas 163. In some embodiments, all pixel areas having a center location located between the maximum Z-coordinate value (Z1) and the minimum Z-coordinate value (−Z1) can be undistorted pixel areas 163. In some embodiments, at least 90% of the pixel areas having a center location located between the maximum Z-coordinate value (Z1) and the minimum Z-coordinate value (−Z1) can be undistorted pixel areas 163. As a non-limiting example, for a Z1 value of 1.5 mm and a −Z1 value of −1.5 mm, at least 90% of the pixel areas corresponding to pixels having a Z-coordinate value between −1.5 mm and 1.5 mm can be an undistorted pixel area 163.

In some embodiments, a distorted pixel map (for example, maps 700′ and 710′) can comprise an undistorted width area 730′. In such embodiments, undistorted width area 730′ can comprise undistorted pixel areas 163 and/or distorted pixel areas 163′ that are undistorted in the width direction (i.e., only distorted in the height direction). In some embodiments, undistorted width area 730′ can comprise only undistorted pixel areas 163 and/or distorted pixel areas 163′ that are undistorted in the width direction (i.e., only distorted in the height direction). In some embodiments, at least 90% of the pixel areas within undistorted width area 730′ are undistorted pixel areas 163 and/or distorted pixel areas 163′ that are undistorted in the width direction (i.e., only distorted in the height direction).

In some embodiments, undistorted width area 730′ can be defined by an area within the localized Cartesian coordinate system having a second maximum Z-coordinate value of Z2 and a second minimum Z-coordinate value of −Z2. In some embodiments, Z2 can be 2 mm, 2.5 mm, 3 mm, 3.5 mm, or 4 mm. In some embodiments, −Z2 can be −2 mm, −2.5 mm, −3 mm, −3.5 mm, or −4 mm. In some embodiments, Z2 can range from 2 mm to 4 mm, or from 2 mm to 3 mm. In some embodiments, −Z2 can range from −2 mm to −4 mm, or from −2 mm to −3 mm.

In embodiments comprising undistorted width area 730′, pixel areas having a center location located between the maximum Z-coordinate value (Z2) and the minimum Z-coordinate value (−Z2) can be undistorted pixel areas 163 or distorted pixel areas 163′ that are undistorted in the width direction. In some embodiments, all pixel areas in area 730′ having a center location located between the maximum Z-coordinate value (Z2) and the minimum Z-coordinate value (−Z2) can be undistorted pixel areas 163 or distorted pixel areas 163′ that are undistorted in the width direction. In some embodiments, at least 90% of the pixel areas in area 730′ having a center location located between the maximum Z-coordinate value (Z2) and the minimum Z-coordinate value (−Z2) can be undistorted pixel areas 163 or distorted pixel areas 163′ that are undistorted in the width direction. As a non-limiting example, for a Z2 value of 2.5 mm and a −Z2 value of −2.5 mm, at least 90% of the pixel areas corresponding to pixels having a Z-coordinate value between −2.5 mm and 2.5 mm can be undistorted in the width direction.

In some embodiments, undistorted width area 730′ can further comprise an area defined by an area within the localized Cartesian coordinate system having a first maximum Y-coordinate value of Y1, a first minimum Y-coordinate value of −Y1, a third maximum Z-coordinate value of Z3, and a third minimum Z-coordinate value of −Z3. In some embodiments, Y1 can be 1 mm, 1.5 mm, 2 mm, 2.5 mm, or 3 mm. In some embodiments, −Y1 can be −1 mm, −1.5 mm, −2 mm, −2.5 mm, or −3 mm. In some embodiments, Y1 can range from 1 mm to 3 mm, or from 1 mm to 2 mm. In some embodiments, −Y1 can range from −1 mm to −3 mm, or from −1 mm to −2 mm. In some embodiments, Z3 can be 5 mm, 5.5 mm, 6 mm, 6.5 mm, or 7 mm. In some embodiments, −Z3 can be 5 mm, 5.5 mm, 6 mm, 6.5 mm, or 7 mm. In some embodiments, Z3 can range from 5 mm to 7 mm, or from 5 mm to 6 mm. In some embodiments, −Z3 can range from −5 mm to −7 mm, or from −5 mm to −6 mm.

In some embodiments comprising undistorted width area 730′, pixel areas having a center location located between Y1 and −Y1, and between Z3 and −Z3 can be undistorted pixel areas 163 or distorted pixel areas 163′ that are undistorted in the width direction. In some embodiments, all pixel areas in area 730′ having a center location located between Y1 and −Y1, and between Z3 and −Z3 can be undistorted pixel areas 163 or distorted pixel areas 163′ that are undistorted in the width direction. In some embodiments, at least 90% of the pixel areas in area 730′ having a center location located between Y1 and −Y1, and between Z3 and −Z3 can be undistorted pixel areas 163 or distorted pixel areas 163′ that are undistorted in the width direction. As a non-limiting example, for a Y1 value of 1.5 mm, a −Y1 value of −1.5 mm, a Z3 value of 5.5 mm, and a −Z3 value of −5.5 mm, at least 90% of the pixel areas corresponding to pixels having a Y-coordinate value between −1.5 mm and 1.5 mm and a Z-coordinate value between −5.5 mm and 5.5 mm are undistorted in the width direction.

Pixel areas having a center location located outside of undistorted area 720′ and/or undistorted width area 730′ comprise a width that is elongated in the width direction by a ΔW value and a height that is compressed in the height direction by a ΔH value. Pixel areas elongated in the width direction can be stretched in the width direction such that their width is increased by the ΔW value. Pixel areas compressed in the height direction can be contracted in the height direction such that their height is decreased by the ΔH value. In some embodiments, at least 90% of the pixel areas having a center location located outside of undistorted area 720′ and/or undistorted width area 730′ comprise a width that is elongated in the width direction by a ΔW value and a height that is compressed in the height direction by a ΔH value. The ΔW value is difference between the width of an undistorted pixel 162 and the width of a corresponding distorted pixel area 163′. Similarly, the ΔH value is the difference between the height of an undistorted pixel 162 and the height of a corresponding distorted pixel area 163′.

The quadrant of the localized Cartesian coordinate system in which pixel areas are located can dictate the ΔW value and ΔH value for distorted pixel areas 163′. As a non-limiting example, in a lower-right quadrant, at least 90% of the pixel areas corresponding to pixels having a Z-coordinate value less than −Z3 (e.g., −5.5 mm) and a Y-coordinate value greater than Y1 (e.g., 1.5 mm) can comprise a width that is elongated in the width direction by a ΔW value and a height that is compressed in the height direction by a ΔH value. As another non-limiting example, in an upper-right quadrant, at least 90% of the pixel areas corresponding to pixels having a Z-coordinate value greater than Z3 (e.g., 5.5 mm) and a Y-coordinate value greater than Y1 (e.g., 1.5 mm) can comprise a width that is elongated in the width direction by a ΔW value and a height that is compressed in the height direction by a ΔH value. Similar relationships can be present in the lower-left and upper-left quadrants.

In some embodiments, in the lower-right quadrant, as the Z-coordinate value of the pixels decreases, the ΔW value increases and the ΔH value increases. In some embodiments, in the upper-right quadrant, as the Z-coordinate value of the pixels increases, the ΔW value increases and the ΔH value increases. In some embodiments, in the lower-left quadrant, as the Z-coordinate value of the pixels decreases, the ΔW value increases and the ΔH value increases. In some embodiments, in the upper-left quadrant, as the Z-coordinate value of the pixels increases, the ΔW value increases and the ΔH value increases. In some embodiments, the distortion in a plurality of the quadrants can be symmetrical. In some embodiments, the distortion in all four quadrants can be symmetrical.

In some embodiments, the ΔW value can increase at a first rate and the ΔH value can increase at a second rate less than the first rate. In some embodiments, the ΔW value can increase at a first rate and the ΔH value can increase at a second rate greater than the first rate.

The ΔW value can increase to a maximum width distortion (for example, maximum width distortion 702′). Similarly, the ΔH value can increase to a maximum height distortion (for example, maximum height distortion 704′). In some embodiments, the maximum width distortion 702′ can be greater than the maximum height distortion 704′. In some embodiments, the maximum width distortion 702′ can be less than the maximum height distortion 704′

The maximum width distortion 702′ and the maximum height distortion 704′ can be based on the size and relative location of the pixel map. As a non-limiting example, distorted pixel map 700′ based on an undistorted pixel map 700 comprising a 19-mm width and a 19-mm height centered on equator 138 can have a maximum width distortion 702′ of about 0.66 mm and a maximum height distortion 704′ of about 0.31 mm. As another non-limiting example, distorted pixel map 710′ based on an undistorted pixel map 710 comprising a 9-mm width, a 9-mm height, and a top edge located about 3.5 mm below the equator 138 can have a maximum width distortion 712′ of about 0.64 mm and a maximum height distortion 714′ of about 0.99 mm.

As shown for example in FIG. 8, distorted pixel maps for image area profiles 152 located at different points on a ball 100 can be distorted in the same manner, except that the size of the map and the relative distortion of distorted pixel areas 163′ can be based on the size and location of the image area profile 152. FIG. 8 shows distorted pixel maps 700′ and 710′ overlaid on top of each other. Both maps follow the same overall distortion pattern at areas where the maps 700′ and 710′ overlap in the overlay. In the example shown, distorted pixel map 710′ includes a plurality of distorted pixel areas 163′ located outside of pixel map 700′ because distorted pixel map 710′ is for an image area profile 152 that includes pixels having center points located below the bottom-most distorted pixel areas 163′ for map 700′.

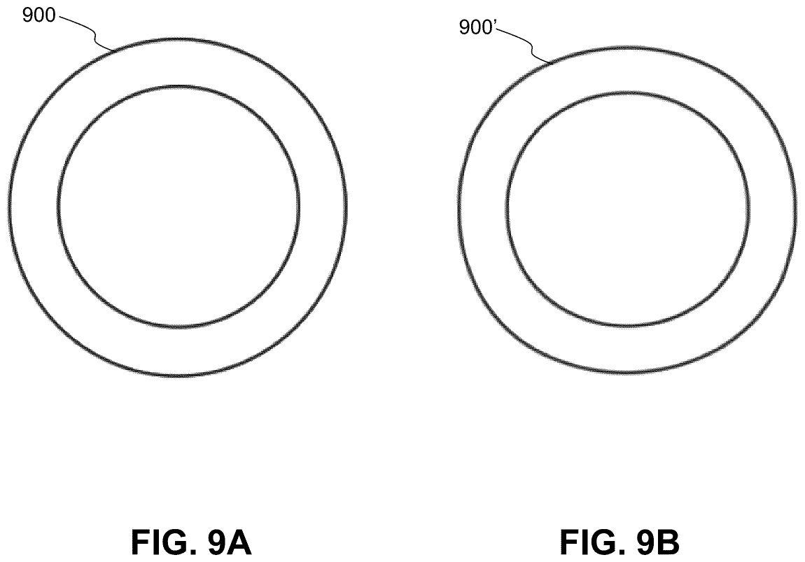

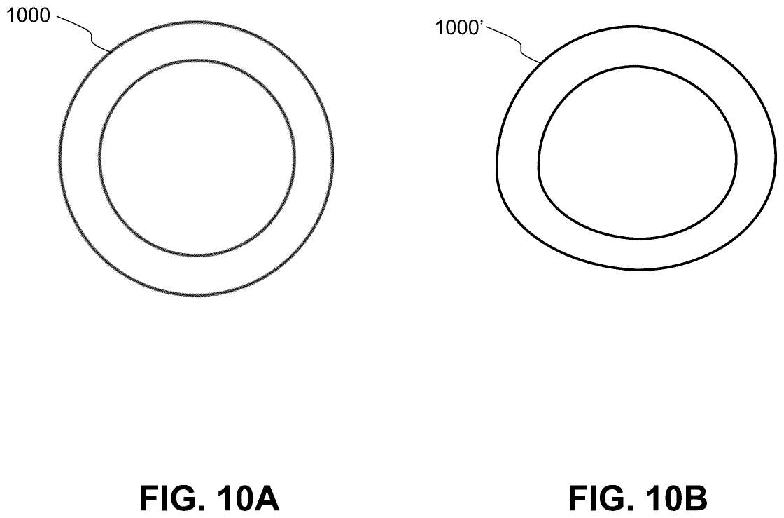

The size and the relative location of an image area profile 152 distorted according to a distorted pixel map can dictate the degree of distortion and therefore the distorted shape for the image area profile. As a non-limiting example, FIG. 9A shows an undistorted ring 900 having an outer dimeter of 19 mm. FIG. 9B shows a distorted ring 900′ created by distorting ring 900 based on distorted pixel map 700′. As another non-limiting example, FIG. 10A shows an undistorted ring 1000 having an outer dimeter of 9 mm. FIG. 10B shows a distorted ring 1000′ created by distorting ring 1000 based on distorted pixel map 710′.

As discussed above, during or after pre-distorting an image area profile 152 according to a distorted pixel map (e.g., map 700′ or map 710′), undistorted pixel areas 163 and/or distorted pixel areas 163′ can be selectively removed from the distorted pixel map. In some embodiments, undistorted pixel areas 163 and/or distorted pixel areas 163′ can be selectively removed from pixel area rows 169 of distorted pixel map. In some embodiments, a number of pixels areas 163, 163′ removed from a pixel area row 169 can be based on the Z-coordinate value of the pixels 162 corresponding to the pixels areas 163, 163′ in the row 169. In some embodiments, as the Z-coordinate value of the pixels 162 corresponding to the pixels areas 163, 163′ in the row 169 increases, the number of pixels areas 163, 163′ removed from the pixel area row 169 can increase. In other words, more pixel areas 163, 163′ can be selectively removed from rows as the location of pixels areas 163, 163′ moves further from the equator 138 of a ball. For example, a first number of pixel areas 163, 163′ can removed from a first pixel area row 169 corresponding to pixels 162 having a first Z-coordinate value and a second number of pixel areas 163, 163′ can be removed from a second pixel area row 169 corresponding to pixels 162 having a second Z-coordinate value. In such embodiments, the absolute value of the first Z-coordinate value is greater than the absolute value of the second Z-coordinate value and the first number is greater than the second number.

FIG. 11 illustrates an exemplary distorted pixel map 700′ with pixel areas 163, 163′ removed according to some embodiments. As illustrated in FIG. 11, the topmost and bottommost pixel area rows 169 each comprise five removed pixel areas 166. The number of removed pixel areas 166 decreases as the rows approach the center point (i.e., the (0, 0) point). While FIG. 11 illustrates specific removed pixel areas 166, any number of pixel areas 163, 163′ can be removed from any number of pixel areas rows 169 depending on, the location of an image 150 on a ball, the size of an image area profile 152, characteristics (e.g., the shape and negative space) of the image 150, or a combination thereof. Further, solely for illustration purposes, FIG. 11 shows a pixel map 700′ comprising a representative grid of pixel areas. However, it should be appreciated that pixelated images areas and pixel maps for an image can comprise any number of pixels/pixel areas. The number of pixels/pixel areas can be based on the desired size and resolution of an image. Accordingly, the number pixel areas and the number of removed pixel areas 166 can be significantly more than what is illustrated in FIG. 11.

In some embodiments, no pixel areas 163 may be removed from pixel area rows of a pixel map defined by pixel areas corresponding to pixels having a Z-coordinate value between the maximum Z-coordinate value (Z1) and the minimum Z-coordinate value (−Z1) described above. As a non-limiting example, no pixel areas 163 may be removed for pixel areas corresponding to pixels having a Z1 value less than or equal to 1.5 mm and a −Z1 value of greater than or equal to −1.5 mm.

In some embodiments, no pixel areas 163 may be removed from pixel area rows of a pixel map defined by pixel areas corresponding to pixels having a Z-coordinate value between the maximum Z-coordinate value (Z2) and the minimum Z-coordinate value (−Z2) described above. As a non-limiting example, no pixel areas 163 may be removed for pixel areas corresponding to pixels having a Z2 value less than or equal to 2.5 mm and a −Z2 value of greater than or equal to −2.5 mm.

As discussed above, any number of images can be printed on ball 100 using the single pass printing methods as described herein. In some embodiments, multiple images can be printed simultaneously by one printer head 102. In some embodiments, multiple images can be printed sequentially using multiple printer heads 102. In some embodiments, different portion of the image(s) can be printed using different printer heads 102. For example, different printer heads 102 can print differently colored portions of the image(s).

In some embodiments, a plurality of printer heads 102 can be utilized to print different colors. For example, in such embodiments, a printed image 150 comprising features printed with three different colors (for example, black, magenta, and cyan) can be printed using three different printer heads 102 arranged in a serial arrangement so as to apply each color in successive stages of printing. In some embodiments, the printer heads 102 can be capable of printing in at least five colors including cyan, magenta, yellow, black, and white. That said, it is possible to print in any number of colors beyond the CMYK inks depending on how many printer heads 102 are available.

In order to increase resolution of a printed image in the lateral sense, it is possible to add additional printer heads in the print direction and offset them by a certain number of pixels to double or triple the dots per inch (dpi) in the in track while running at maximum speed. The print width can also be increased by adding printer heads in the cross track to increase the print swath by a factor of the printer head width.

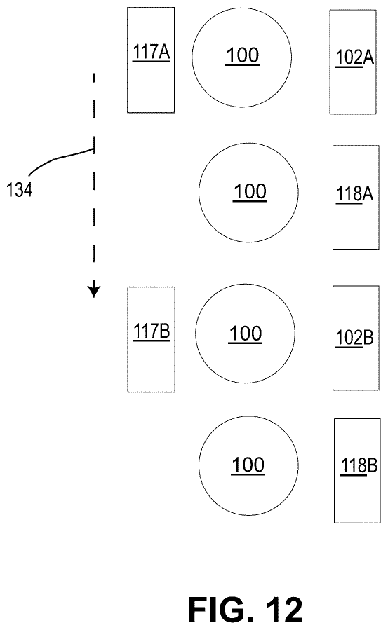

FIG. 12 illustrates a top view of the golf ball 100 as it moves along a linear direction 134 and passes adjacent to a plurality of printer heads 102 according to some embodiments. In some embodiments, a first printer head 102A at a first printer station can apply a first color (for example, yellow). After the first color is applied, the golf ball 100 can pass through a first ink curing station 118A before proceeding to a second printer head 102B at a second printer station to apply a second color (for example, magenta). After the second color is applied to the golf ball 100, ball 100 can be cured at a second ink curing station 118B. In some embodiments, the first and/or second ink curing stations 118A, 118B can perform a UV pinning operation where low power level UV light is applied. In some embodiments, the second ink curing station 118B can additionally or alternatively comprise a final curing station where a higher power level of UV light (when compared to the UV pinning operation) is applied to cure all the ink applied to golf ball 100. This process can be repeated for as many colors as required for printing a certain image. In some embodiments, there can be from 1 to 20 printer heads 102 and from 1 to 20 curing stations 118. In some embodiments, there can be two or more printer heads 102 per printer station applying at least two or more different colors on golf ball 100 simultaneously.

In some embodiments, a first printer head 102A at a first printer station can apply a first color (for example, yellow) over two or more rotations of ball 100 at the printer head. In such embodiments, a first set of ink droplets can be printed with a first set of nozzles 103 on the printer head 102A (for example, the odd numbered nozzles) during a first rotation of the ball 100 and a second set of ink droplets can be printed with a second set of nozzles 103 on the printer head 102A different from the first set (for example, the even numbered nozzles) during a second rotation of the ball 100. In some embodiments, the first printer head 102A can comprise an ink curing device 117A configured to cure the first set of ink droplets during the first rotation and cure the second set of ink droplets during the second rotation. In some embodiments, the ink curing device 117A can perform a UV pinning operation where a low power level UV light is applied. In some embodiments, the ink curing device 117A can perform a full UV curing operation. In some embodiments, the single pass printing system may not comprise an ink curing station 118 between the first printer head 102A and a second printer head 102B. Rather, the system can comprise a final UV curing station 118 positioned such that the ball 100 passes through the final UV curing station 118 after passing through the necessary number of printer heads needed to apply an image.

In some embodiments, after the first color is applied in two or more rotations at printer head 102A, the golf ball 100 can pass through a first ink curing station 118A before proceeding to a second printer head 102B to apply a second color (for example, magenta).

In some embodiments, the second printer head 102B can apply a second color (for example, magenta) over two or more rotations of ball 100 at the printer head. In such embodiments, a first set of ink droplets can be printed with a first set of nozzles 103 on the printer head 102B (for example, the odd numbered nozzles) during a first rotation of the ball 100 and a second set of ink droplets can be printed with a second set of nozzles 103 on the printer head 102B different from the first set (for example, the even numbered nozzles) during a second rotation of the ball 100. In some embodiments, the second printer head 102B can comprise an ink curing device 117B configured to cure the first set of ink droplets during the first rotation and cure the second set of ink droplets during the second rotation. In some embodiments, the ink curing device 117B can perform a UV pinning operation where a low power level UV light is applied. In some embodiments, the ink curing device 117B can perform a full UV curing operation. In some embodiments, the single pass printing system may not comprise an ink curing station 118 between the second printer head 102B and a third printer head.

In some embodiments, after the second color is applied in two or more rotations at printer head 102B, the golf ball 100 can pass to a third printer head. This process can be repeated for as many colors as required for printing a certain image. In some embodiments, there can be from 1 to 20 printer heads 102 and from 1 to 20 curing stations 118.

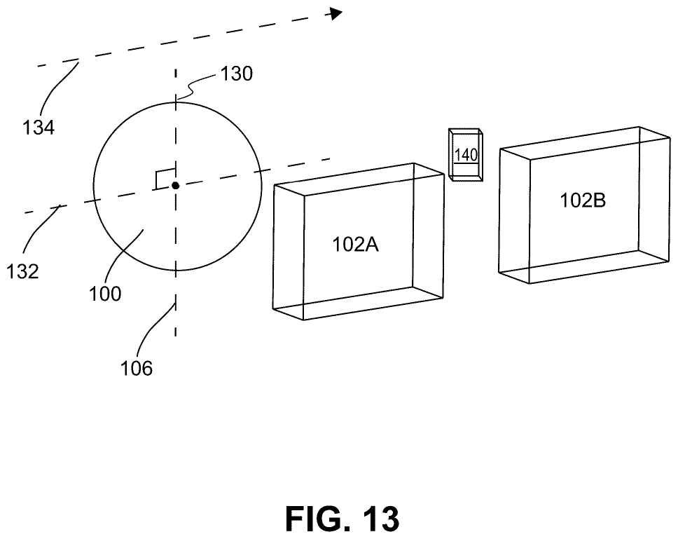

As shown in FIG. 13, in some embodiments, the first printer head 102A can be located at a rotational printing station, meaning that the golf ball 100 is rotated on axis 106 relative to the first printer head 102A during printing of all or a portion of an image on the golf ball 100. Additionally, a second printer head 102B can be utilized in the manufacturing process to print another portion of the image printed by head 102A or a different image from that printed by head 102A. In some embodiments, the second printer head 102B can be located at a linear printing station where the second printer head 102B is stationary and the golf ball 100 is moved without rotation and linearly, or at least in one direction, past the second printer head 102B during printing.

In some embodiments, the first printer head 102A can be located at a linear printing station and the second printer head 102B can be located at a rotational printing station. In some embodiments, the first printer head 102A and the second printer head 102B can both be located at rotational printing stations. In some embodiments, the first printer head 102A and the second printer head 102B can both be located at linear printing stations. In some embodiments, the printing system can comprise a reorientation mechanism located between the first printer head 102A and the second printer head 102B to rotate the golf ball 100 by about 90 degrees, or from 45 degrees to 135 degrees along second central axis 132 that is perpendicular to rotation axis 106.

In some embodiments, the digital encoder 120 can rotate the golf ball 100 45 degrees to 90 degrees about axis 106 between the first printer head 102A and the second printer head 102B in order to print different images on the golf ball 100 at different locations on the ball. In some embodiments, additionally or alternatively, a ball rotation mechanism 140 can rotate the golf ball 100 45 degrees to 90 degrees about axis 132 between the first printer head 102A and the second printer head 102B in order to print different images on the golf ball 100 at different locations on the ball. In such embodiments, the ball rotation mechanism 140 can be a mechanical mechanism with an encoder/decoder, a mechanical arm, a friction based contact member, or any other mechanical, electrical, or pneumatic device utilized to rotate the golf ball 100 about axis 132.

As illustrated in FIGS. 12 and 13, the printer heads 102 can be located on the right hand side of the linear direction 134 in some embodiments. However, at any of the printing stations described herein, a printer head 102 can alternatively or additionally be located on the left hand side of linear direction 134, behind the ball, in front of the ball, above the ball, or below the ball.

In some embodiments, the speed at which the ball 100 moves along the linear direction 134 can be 14 inches/see for a 360 dpi printer resolution. If a 540 dpi printer head is utilized, the speed of the ball movement can range from 10 to 12 inches/sec. In some embodiments, the ratio of the printer resolution divided by the linear direction speed can range from 10 dpi/(inches/sec) to 100 dpi/(inches/sec) or from 20 dip/(inches/sec) to 50 dpi/(inches/sec). In some embodiments, the speed at which balls 100 are printed can range from 20 to 300 balls per minute or from 100 to 250 balls per minute.

In some embodiments, the devices 117 or the curing stations 118 can perform a UV pinning operation and comprise lamps with a power rating of between 0 to 20 watts or from 1.5 watts to 7.5 watts to partially cure the ink applied at a printing station. In some embodiments, the UV curing can be accomplished by mercury arc UV curing lamps or LED curing lamps. In some embodiments, a UV pinning operation can use lamps of a lower wattage than a final UV curing lamp. For example, pinning lamps can have a power rating of 5 W or less while final UV curing lamps can have a power rating of more than 5 W, or from 5 W to 15 W. In some embodiments, photo initiators can be present in the printed ink to narrow the wavelength of light in which curing occurs to reduce ambient light contamination during the curing process. In some embodiments, the energy density of a curing lamp can range from 100 mJ/cm² to 5000 mJ/cm², or from 150 mJ/cm² to 3000 mJ/cm². In some embodiments, the pinning lamps can have an energy density that is less than the final curing lamps. For example, the pinning lamps can have an energy density ranging from 50 mJ/cm² to 200 mJ/cm² while the final UV curing lamps can have an energy density ranging from 1 J/cm² to 5 J/cm².

In some embodiments, golf ball 100 can have core and a cover layer surrounding the core. In certain embodiments, golf ball 100 can have a core, at least one mantle layer, and a cover layer. In some embodiments, the golf ball 100 can be a two-piece ball, a three-piece ball, a four-piece ball, a five-piece ball, or a six-piece ball.

The term “core” is intended to mean the elastic center of a golf ball. The core may be a unitary core having a center it may have one or more “core layers” of elastic material, which are usually made of rubbery material such as diene rubbers.

The term “cover layer” is intended to mean the outermost layer of the golf ball; this is the layer that is directly in contact with paint and/or ink on the surface of the golf ball. If the cover consists of two or more layers, only the outermost layer is designated the cover layer, and the remaining layers (excluding the outermost layer) are commonly designated intermediate layers as herein defined. The term “outer cover layer” as used herein is used interchangeably with the term “cover layer.”

The term “mantle layer” may be used interchangeably herein with the terms “intermediate layer” and is intended to mean any layer(s) in a golf ball disposed between the core and the outer cover layer. Should a ball have more than one mantle layer, these may be distinguished as “inner intermediate layer” or “inner mantle layer” which terms may be used interchangeably to refer to the intermediate layer nearest the core and furthest from the outer cover, as opposed to the “outer intermediate layer” or “outer mantle layer” which terms may also be used interchangeably to refer to the intermediate layer furthest from the core and closest to the outer cover, and if there are three intermediate layers, these may be distinguished as “inner intermediate layer” or “inner mantle layer” which terms are used interchangeably to refer to the intermediate or mantle layer nearest the core and furthest from the outer cover, as opposed to the “outer intermediate layer” or “outer mantle layer” which terms are also used interchangeably to refer to the intermediate layer further from the core and closer to the outer cover, and as opposed to the “intermediate layer” or “intermediate mantle layer” which terms are also used interchangeably to refer to the intermediate layer between the inner intermediate layer and the outer intermediate layer.

The cover layer can be used with golf balls of any desired size. “The Rules of Golf” by the USGA dictate that the size of a competition golf ball must be at least 1.680 inches in diameter; however, golf balls of any size can be used for leisure golf play. The preferred diameter of the golf balls is from about 1.680 inches to about 1.800 inches. The more preferred diameter is from about 1.680 inches to about 1.760 inches. A diameter of from about 1.680 inches to about 1.740 inches is most preferred; however, diameters anywhere in the range of from 1.70 to about 2.0 inches can be used. Oversize golf balls with diameters above about 1.760 inches to as big as 2.75 inches are also within the scope of the invention.

Each of the mantle layers of the golf balls may have a thickness of less than 0.080 inch, more particularly less than 0.065 inch, and most particularly less than 0.055 inch.

In certain embodiments, the inner mantle may have a material Shore D hardness of 15 to 65, particularly 25 to 60, and more particularly 30 to 58. The inner mantle may have a flexural modulus of 2 to 35, particularly 10 to 30, and more particularly 15 to 35, kpsi. The intermediate mantle may have a flexural modulus of 10 to 50, particularly 25 to 50, and most particularly 25 to 40, kpsi, and a material Shore D hardness of 40 to 70, more particularly from 45 to 65, and most particularly from 50 to 60. The outer mantle may have a material Shore D hardness of 55 to 75, particularly 58 to 70, and more particularly 60 to 68. The outer mantle material may have a flexural modulus of 30 to 80, particularly 40 to 80, and most particularly 50 to 75, kpsi. The core and mantle layer(s) may each include one or more of the following polymers.

Such polymers include synthetic and natural rubbers, thermoset polymers such as thermoset polyurethanes and thermoset polyureas, as well as thermoplastic polymers including thermoplastic elastomers such as unimodal ethylene/carboxylic acid copolymers, unimodal ethylene/carboxylic acid/carboxylate terpolymers, bimodal ethylene/carboxylic acid copolymers, bimodal ethylene/carboxylic acid/carboxylate terpolymers, unimodal ionomers, bimodal ionomers, modified unimodal ionomers, modified bimodal ionomers, thermoplastic polyurethanes, thermoplastic polyureas, polyesters, copolyesters, polyamides, copolyamides, polycarbonates, polyolefins, polyphenylene oxide, polyphenylene sulfide, diallyl phthalate polymer, polyimides, polyvinyl chloride, polyamide-ionomer, polyurethane-ionomer, polyvinyl alcohol, polyarylate, polyacrylate, polyphenylene ether, impact-modified polyphenylene ether, polystyrene, high impact polystyrene, acrylonitrile-butadiene-styrene copolymer styrene-acrylonitrile (SAN), acrylonitrile-styrene-acrylonitrile, styrene-maleic anhydride (S/MA) polymer, styrenic copolymer, functionalized styrenic copolymer, functionalized styrenic terpolymer, styrenic terpolymer, cellulose polymer, liquid crystal polymer (LCP), ethylene-propylene-diene terpolymer (EPDM), ethylene-vinyl acetate copolymers (EVA), ethylene-propylene copolymer, ethylene vinyl acetate, polyurea, and polysiloxane and any and all combinations thereof. One example is PARALOID™ EXL 2691A which is a methacrylate-butadiene-styrene (MBS) impact modifier available from Rohm & Haas Co.

Embodiments of the present disclosure can be implemented in hardware, firmware, software application, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

1. A single pass printing method for a spherical ball, the method comprising:
rotating the spherical ball on a central axis of the ball,
printing an image on the ball with a plurality of printing nozzles while the ball is rotating;
wherein:
the image on the ball is defined by an image area profile comprising a top boundary line and a bottom boundary line;
the image is printed by printing ink droplets correlating to pixels arranged in consecutive image lines, each image line defined by a plurality of the pixels disposed between the top boundary line and the bottom boundary line, and each pixel comprising at least one of the ink droplets that forms the image; and
the ink droplets are printed by:
applying the pixels to a distorted pixel map comprising pixel areas corresponding with the pixels and comprising a plurality of undistorted pixel areas and a plurality of pixel areas distorted in at least one of a width direction and a height direction,
selectively removing pixels areas from the distorted pixel map,
printing the ink droplets based on the distorted pixel map with the pixel areas removed.

2. The single pass printing method of claim 1, wherein a center location of each pixel is defined by Cartesian coordinates in a polar coordinate system where: r is the radius of the ball in millimeters, the x-y plane is defined by a first central plane of the ball perpendicular to the central axis, the x-z plane is defined by a second central plane of the ball perpendicular to the first central plane, and a center point for the image area profile in the Cartesian coordinates is defined by an intersection of the ball's equator about the central axis and a vertical center line of the image area profile.

3. The single pass printing method of claim 2, wherein at least 90% of the pixel areas corresponding to pixels having a Z-coordinate value between −1.5 mm and 1.5 mm are undistorted pixel areas.

4. The single pass printing method of claim 2, wherein at least 90% of the pixel areas corresponding to pixels having a Z-coordinate value between −2.5 mm and 2.5 mm are undistorted in the width direction.

5. The single pass printing method of claim 2, wherein at least 90% of the pixel areas corresponding to pixels having a Y-coordinate value between −1.5 mm and 1.5 mm and a Z-coordinate value between −5.5 mm and 5.5 mm are undistorted in the width direction.

6. The single pass printing method of claim 2, wherein at least 90% of the pixel areas corresponding to pixels having a Z-coordinate value less than −5.5 mm and a Y-coordinate value greater than 1.5 mm comprises a width that is elongated in the width direction by a ΔW value and a height that is compressed in the height direction by a ΔH value.

7. The single pass printing method of claim 6, wherein, as the Z-coordinate value of the pixels decreases, the ΔW value increases and the ΔH value increases.

8. The single pass printing method of claim 7, wherein the ΔW value increases at a first rate and the ΔH value increases at a second rate that is less than the first rate.

9. The single pass printing method of claim 2, wherein the distorted pixel map comprises pixel area rows defined by pixel areas corresponding to pixels having the same Z-coordinate value.

10. The single pass printing method of claim 9, wherein a number of pixels areas removed from a pixel area row of the distorted pixel map is based on the Z-coordinate value of the pixels corresponding to the pixel area row.

11. The single pass printing method claim 10, wherein:
a first number of pixel areas is removed from a first pixel area row corresponding to pixels having a first Z-coordinate value,
a second number of pixel areas is removed from a second pixel area row corresponding to pixels having a second Z-coordinate value,
wherein the absolute value of the first Z-coordinate value is greater than the absolute value of the second Z-coordinate value, and
the first number is greater than the second number.

12. The single pass printing method of claim 9, wherein no pixel areas are removed from pixel area rows of the distorted pixel map defined by pixel areas corresponding to pixels having a Z-coordinate value between −1.5 mm and 1.5 mm.

13. The single pass printing method of claim 1, wherein:
the image is a first image and the method comprises printing a second image while the ball is rotating;
the second image is defined by a second image area profile comprising a second top boundary line and a second bottom boundary line;
the second image is printed by printing ink droplets correlating to pixels arranged in consecutive image lines, each image line defined by a plurality of the pixels disposed between the second top boundary line and the second bottom boundary line, and each pixel comprising at least one of the ink droplets that forms the second image; and
the ink droplets of the second image are printed by:
applying the pixels to a second distorted pixel map comprising pixel areas corresponding with the pixels of the second image area profile and comprising a plurality of undistorted pixel areas and a plurality of pixel areas distorted in at least one of a width direction and a height direction,
selectively removing pixel areas from the second distorted pixel map, and
printing the ink droplets of the second image based on the second distorted pixel map with the pixel areas removed.

14. The single pass printing method of claim 13, wherein the vertical center line of the first image is separated from a vertical center line of the second image by an arc distance ranging from 30 mm to 35 mm.

15. The single pass printing method of claim 13, wherein the vertical center line of the first image is separated from a vertical center line of the second image by an arc distance equal to about 25% of a circumference of the ball.

16. The single pass printing method of claim 13, wherein a center location of each pixel for both the first image area profile and the second image area profile is defined by Cartesian coordinates in a polar coordinate system where: r is the radius of the ball in millimeters, the x-y plane is defined by a first central plane of the ball perpendicular to the central axis, the x-z plane is defined by a second central plane of the ball perpendicular to the first central plane, and a center point for the second image area profile in the Cartesian coordinates is defined by an intersection of the ball's equator about the central axis and a vertical center line of the second image area profile, and
where a geometrical center of the first image area profile is located on the x-y plane and a geometrical center of the second image area profile is located below in the x-y plane.

17. The single pass printing method of claim 13, wherein:
a center location of each pixel for the second image area profile is defined by Cartesian coordinates in a polar coordinate system where: r is the radius of the ball in millimeters, the x-y plane is defined by a first central plane of the ball perpendicular to the central axis, the x-z plane is defined by a second central plane of the ball perpendicular to the first central plane, and a center point for the second image area profile in the Cartesian coordinates is defined by an intersection of the ball's equator about the central axis and a vertical center line of the second image area profile,
the ball comprises a manufacture's logo extending along the x-y plane,
the second image is located below the manufacture's logo on the ball, and
the top boundary line of the second image area profile is separated from a bottom of the logo by an arc distance ranging from 1 mm to 4 mm.

18. The single pass printing method of claim 13, wherein the first image is a first non-numerical image and the second image is a second non-numerical image.

19. The single pass printing method of claim 1, wherein the first image is a non-numerical image.

20. A single pass printing method for a spherical ball, the method comprising:
applying an image to an undistorted pixel map to create a pixelated image area profile for the image;
determining a print location of the image on a surface of the ball;
pre-distorting the pixelated image area profile based on the print location and a distorted pixel map comprising a plurality of undistorted pixel areas and a plurality of pixel areas distorted in at least one of a width direction and a height direction, to thereby create a distorted pixelated image area profile for the image;
selectively removing pixels areas from the distorted pixelated image area profile;
single pass printing the image on the surface of the ball based on the distorted pixelated image area with the pixels areas removed while the ball is rotating on a central axis of the ball.

21. The method of claim 20, wherein the distorted pixelated image area profile is supplied to a single pass printer that prints the image on the surface of the ball.

22. The method of claim 21, wherein the single pass printer removes the pixels areas.

23. The method of claim 20, wherein the image is supplied to a single pass printer, and
wherein the single pass printer pre-distorts the pixelated image area profile, removes the pixels areas, and prints the image on the surface of the ball.

24.-36. (canceled)
